(19) United States
(12) Patent Application Publication
(10) Pub. No.: US 2016/0089727 A1
(43) Pub. Date: Mar. 31, 2016

(54) DRILLING TOOL APPARATUS

(71) Applicant: GRIPPLE LIMITED, Sheffield, South Yorkshire (GB)

(72) Inventors: David Graham Bostock, North East Derbyshire (GB); Paul Andrew Smith, South Yorkshire (GB)

(73) Assignee: GRIPPLE LIMITED, Sheffield, South Yorkshire (GB)

(21) Appl. No.: 14/889,298

(22) PCT Filed: May 22, 2014
(86) PCT No.: PCT/GB2014/000202

§ 371 Date: Nov. 5, 2015

(30) Foreign Application Priority Data
May 31, 2013 (GB) 1309740.7
Dec. 11, 2013 (GB) 1321879.7
May 19, 2014 (GB) 1408810.8

(51) Int. Cl. B23B 51/08

(52) U.S. Cl. CPC B23B 51/08; B23B 2260/026

(57) ABSTRACT

A drilling tool apparatus (10) comprises an elongate drilling arrangement (12) for drilling a hole in a wall and an elongate sleeve (14) mountable on the drilling arrangement. The drilling arrangement comprises an elongate shaft (18) having proximal and distal ends (18B, 18A). A cutting means (16) is provided at the distal end of the shaft for forming the hole, wherein the elongate shaft (18) is receivable through the sleeve (14).

This invention relates to drilling tool apparatus. This invention also relates to drilling arrangements. This invention also relates to sleeves for use with drilling arrangements. This invention also relates to methods of drilling holes in walls.

It is often necessary to drill a hole through a wall, in order to feed cables or piping through the wall. It is often difficult to pass the cables through holes drilled in existing walls, because of materials already present within the walls, such as insulation and the like.

One aspect of this invention provides a drilling tool apparatus comprising an elongate drilling arrangement for drilling a hole in a wall and an elongate sleeve mountable on the drilling arrangement, the drilling arrangement comprising an elongate shaft having proximal and distal ends, a cutting means at the distal end of the shaft for forming the hole, wherein the elongate shaft is receivable through the sleeve.

Another aspect of this invention provides a method of drilling a hole in a wall, the method comprising providing a drilling tool apparatus as described above, mounting the sleeve on the drilling arrangement such that the elongate shaft is received through the sleeve, connecting the drilling arrangement to the drill by the connecting means, and drilling said hole in the wall.

A further aspect of this invention provides a sleeve for use with a drilling arrangement in a drilling tool apparatus as described above, the sleeve being elongate and defining an internal space.

A yet further aspect of this invention provides a drilling arrangement comprising an elongate shaft having proximal and distal ends, a cutting means at the distal end of the shaft for forming the hole.

The drilling arrangement may include a connecting means at the proximal end of the shaft to connect the drilling arrangement to a drill. The connecting means may comprise an end of the shaft configured to co-operate with an attaching means on the drill. The connecting means may be configured to co-operate and, be connected, to any desired attaching means on the drill. The attaching means may comprise a chuck. The connecting means may be configured to be received in a chuck of the drill.

The wall may have first and second opposite sides, and the method may comprise drilling the hole through the wall from the first side, disconnecting the drilling arrangement from the drill, and extracting the drilling arrangement from the sleeve and the wall from the second side of the wall.

The sleeve may comprise a substantially cylindrical member, which may have an outer surface and securing means to secure the sleeve in the hole in the wall. The securing means may extend along the sleeve, and may be provided on the outer surface. The securing means may comprise an elongate fin extending along the sleeve. The securing means may comprise a plurality of elongate fins extending along the sleeve.

The, or each, elongate fin may extend outwardly from the outer surface of the sleeve. Desirably, the, or each, elongate fin extends radially outwardly from the outer surface of the sleeve. The, or each, fin may extend substantially the whole length of the substantially cylindrical member.

Alternatively, the securing means may comprise at least one groove defined in the substantially cylindrical member. The securing means may comprise a plurality of grooves defined in the substantially cylindrical member. The grooves may be defined in the outer surface of the sleeve. The, or each, groove may extend substantially the whole length of the substantially cylindrical member.

The sleeve may have an internal space. The substantially cylindrical member may have an inner surface. The inner surface may define the aforesaid inner space. The inner space may extend the length of the sleeve.

The sleeve may have insulation in the internal space. The insulation may be provided on the inner surface. The insulation may define a substantially central elongate bore through which the shaft can extend.

The sleeve may have opposite open ends. When the shaft is received through the sleeve, the proximal end of the shaft may be disposed axially beyond one end of the sleeve. The drilling tool apparatus may include a sleeve protector mountable on the shaft between one end of the sleeve and the proximal end of the shaft. In the embodiments of the invention described herein, the sleeve protector provides the advantage that it protects the sleeve from damage by the drill.

The sleeve protector may comprise a circular member defining a substantially central aperture. The shaft may extend through the central aperture.

In one embodiment, the sleeve protector may be a cylindrical member defining an aperture therethough. In another embodiment, the sleeve protector may comprise a cylindrical body and a radially outwardly extending flange member on the body. A through aperture may be defined by the body and the flange member.

The drilling arrangement may include a locating portion for locating the sleeve on the shaft. The locating portion may be provided on the shaft at the distal end thereof. The locating portion may be provided on the shaft adjacent the drilling arrangement. The locating portion may comprise a shoulder extending from the drilling arrangement to the shaft.

The drilling arrangement may have cutting means for forming the hole. The cutting means may comprise an auger portion, which may comprise a helical member. The cutting means may comprise a cutting tip. The auger portion may have a diameter, and the cutting tip may have a width, the width being larger than the diameter.

The locating portion may be configured to be received within the sleeve. The locating portion may be configured to be a tight fit within the sleeve. The locating portion may be received through the open end of the sleeve.

Embodiments of the invention will now be described by way of example only, with reference to the accompanying drawings, in which:

FIG. 1 is a side view of a drilling arrangement;

FIG. 2 is a side view of a first embodiment of a sleeve for use with the drilling arrangement shown in FIG. 1;

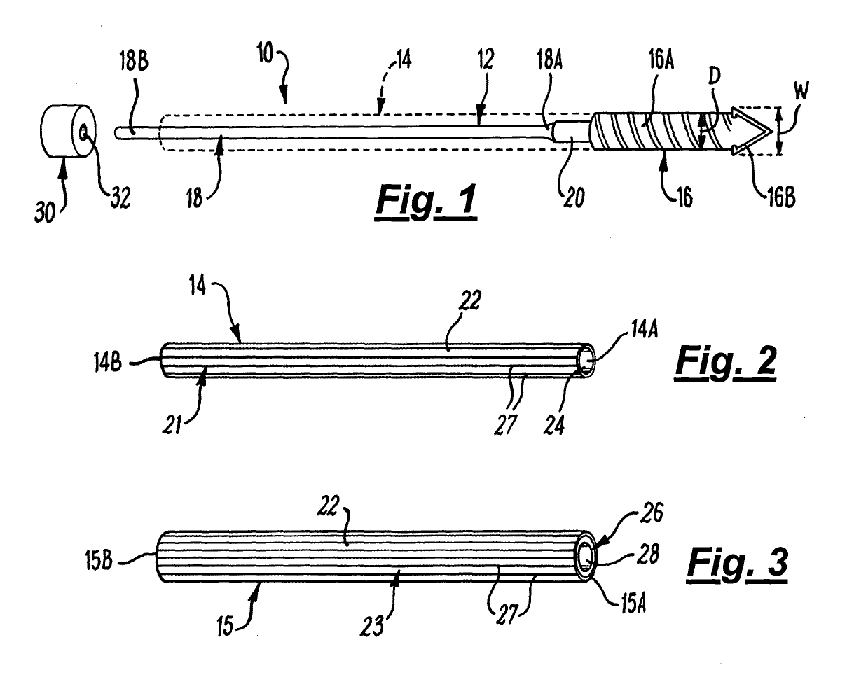

FIG. 3 is a side view of a second embodiment of a sleeve for use in the drilling arrangement shown in FIG. 1;

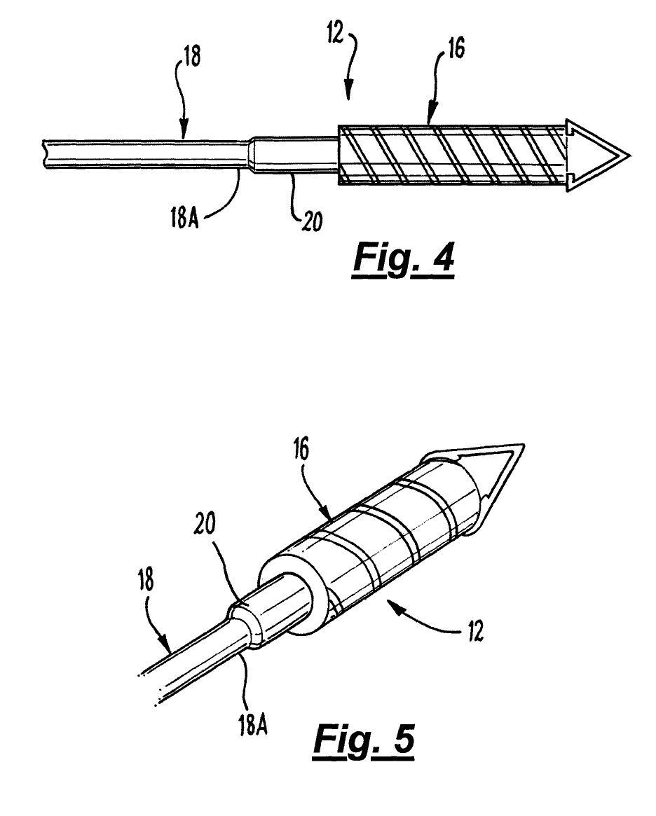

FIG. 4 is a side view of a distal end region of the first embodiment of the drilling arrangement shown in FIG. 1;

FIG. 5 is a perspective view of the distal end region of the drilling arrangement shown in FIG. 1;

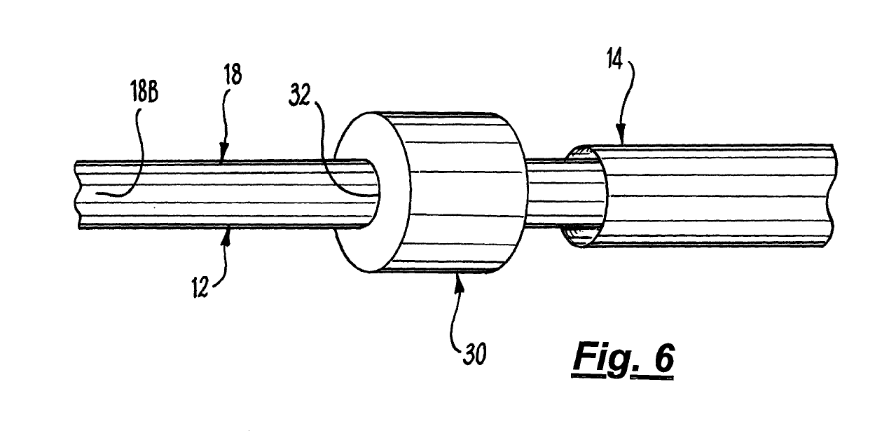

FIG. 6 shows a proximal end region of the first embodiment of the drilling arrangement with a sleeve and a sleeve protector;

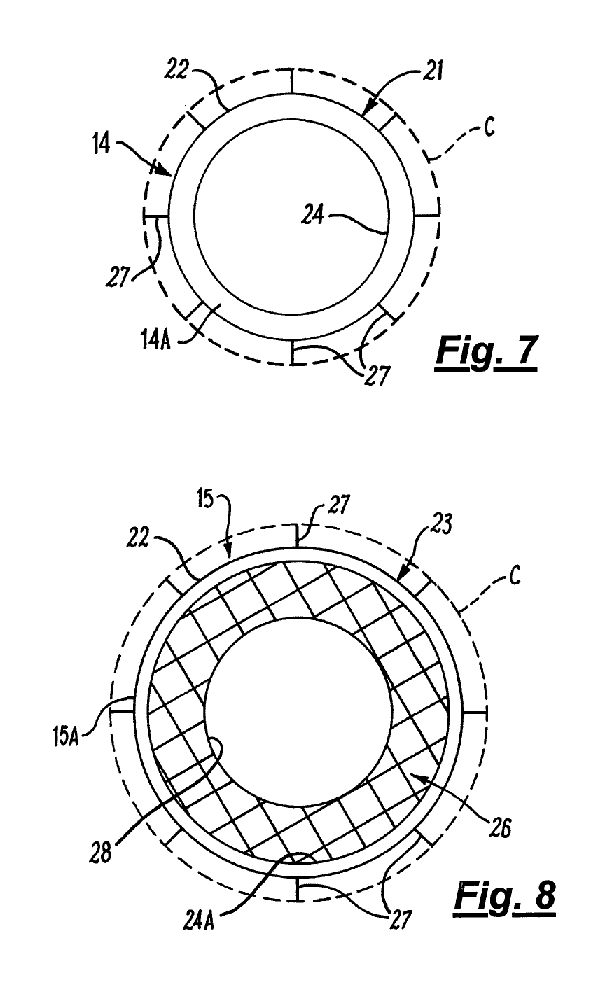

FIG. 7 is an end view of the first embodiment of the sleeve;

FIG. 8 is an end view of the second embodiment of the sleeve;

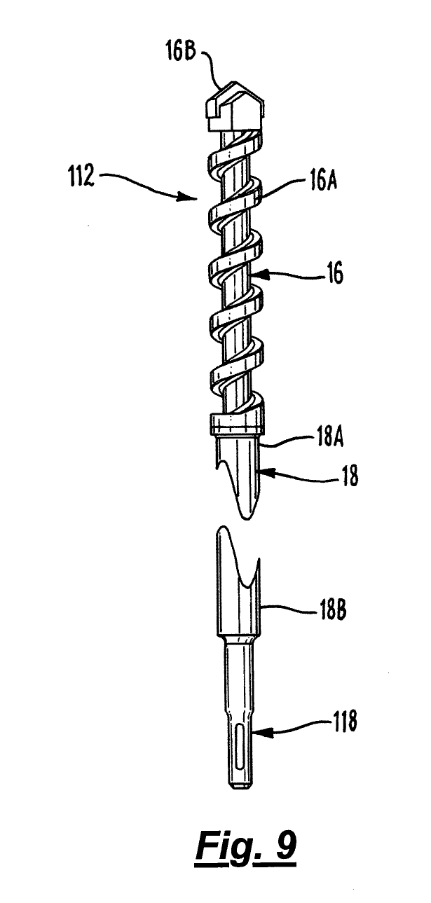

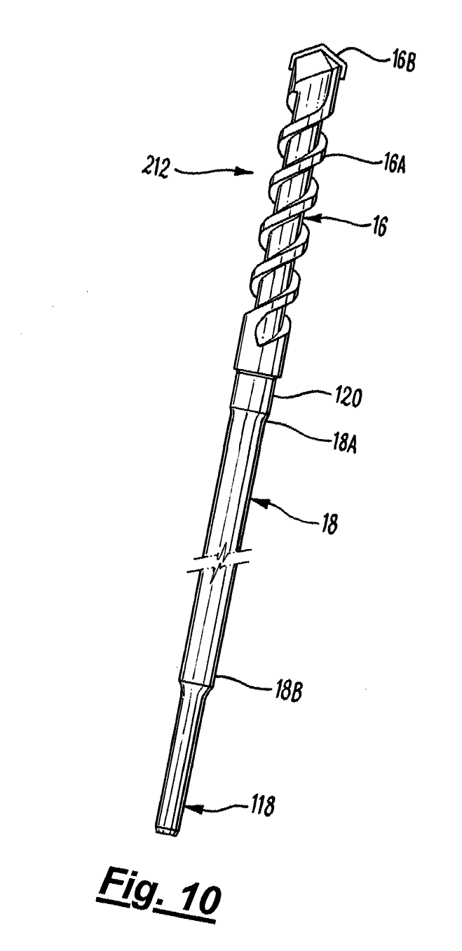

FIG. 9 is a side view of a second embodiment of a drilling arrangement;

FIG. 10 is a side view of a third embodiment of a drilling arrangement;

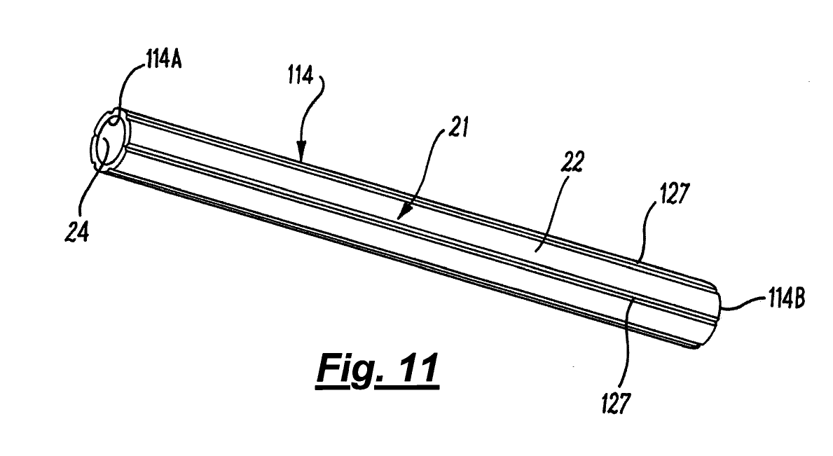

FIG. 11 is a perspective view of a third embodiment of the sleeve;

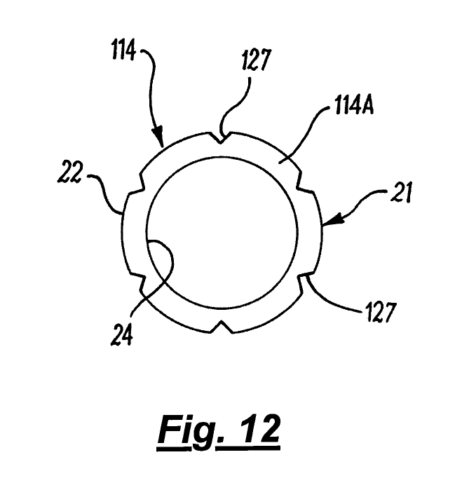

FIG. 12 is an end view of the third embodiment of the sleeve;

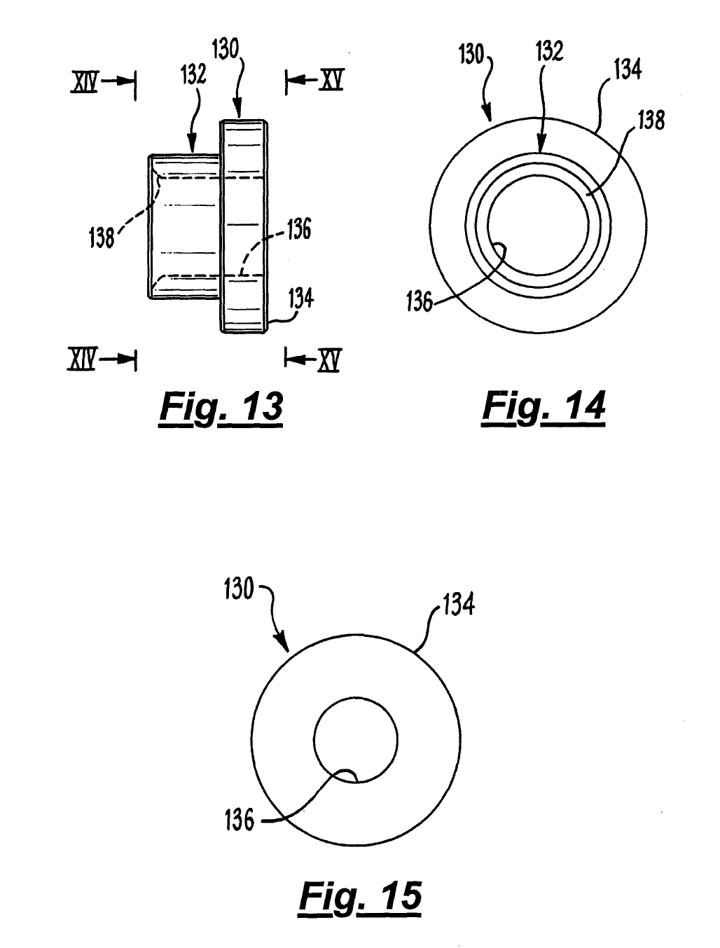

FIG. 13 is a side view of a sleeve protector for the sleeve;

FIG. 14 is a view along the lines XIV-XIV in FIG. 13; and

FIG. 15 is a view along the line XV-XV in FIG. 13.

The drawings show a drilling tool apparatus 10 for drilling a hole entirely through a wall (not shown) from a first side to a second opposite side. The drilling tool apparatus 10 comprises a first embodiment of a drilling arrangement 12 and an elongate sleeve 14. The drilling arrangement 12 comprises cutting means 16 in the form of a drill bit, and an elongate cylindrical shaft 18 extending from the cutting means 16. The cutting means 16 comprises an auger portion 16A comprising a helical member. The cutting means 16 further includes a cutting head 16B. The cutting head 16B has a width W that is slightly wider than the diameter D of the auger portion 16A. The width W and the diameter D will vary from drilling arrangement to drilling arrangement, depending upon the size of the hole to be drilled in the wall.

The shaft 18 has a distal end 18A adjacent the cutting means 16, and a proximal end 18B at the opposite end of the shaft 18. A locating portion in the form of a shoulder 20 extends from the distal end region of the shaft 18 to the cutting means 16. The shoulder 20 has a substantially circular end profile.

A first embodiment of the sleeve 14 is shown in FIGS. 2 and 7, and comprises an elongate hollow substantially cylindrical member 21 having an outer surface 22 and an inner surface 24, and open opposite ends 14A, 14B respectively. The first sleeve 14 defines an internal space 25 that extends the whole length of the first sleeve 14 between the open ends 14A, 14B.

The outer surface 22 of the substantially cylindrical member 21 is provided with radially outwardly extending securing means in the form of a plurality of fins 27, which are spaced from each other circumferentially around the outer surface 22. As shown in FIG. 2, the fins 27 extend axially along the outer surface 22 for substantially the whole length of the first sleeve 14.

A second sleeve is shown in FIGS. 3 and 8, and is designated with the reference numeral 15. The second sleeve 15 is used as an alternative to the first sleeve 14, where insulation is required. The second sleeve 15 comprises an elongate hollow substantially cylindrical member 23 having an outer surface 22 and an inner surface 24A, and open opposite ends 15A, 15B respectively. The second sleeve 15 also includes the fins 27 on the outer surface 22 of the substantially cylindrical member 23. The tips of the fins 27 of the first and second sleeves 14, 15 circumscribe a circle C shown in broken lines in FIGS. 7 and 8.

The second sleeve 15 includes internal insulation 26 on the inner surface 24A of the substantially cylindrical member 23. The insulation 26 extends substantially the whole length of the sleeve 15, and defines a substantially circular central bore 28 extending therethrough between the distal and proximal open ends 15A, 15B.

The first and second sleeves 14, 15 can be made in different sizes, i.e. with different external and internal diameters. The use to which the first or second sleeve 14, 15 is to be put will determine the size of the first or second sleeve 14, 15 selected. In FIGS. 7 and 8, the external diameter of the first sleeve 14 is less than the external diameter of the second sleeve 15. However, it will be appreciated that the relative sizes of the first and second sleeves 14, 15 could be different.

When the sleeve 14 or 15 has been selected, the cutting means 16 is then chosen so that the width W of the cutting head 16B is substantially equal to the diameter of the circle C circumscribed by the tips of the fins 27.

Each of the sleeves 14, 15 may be formed of a suitable plastics material, and may be formed by injection moulding or extrusion. Alternatively, each of the sleeves 14, 15 may be formed of a suitable metal, such as aluminium.

In use of the first sleeve 14, it is mounted on the drilling arrangement 12 such that the shaft 18 extends through the internal space 25 in the first sleeve 14. The sleeve is pushed onto the shaft 18 until the shoulder 20 is received through the open end 14A of the first sleeve 14, thereby holding the first sleeve 14 thereon by friction between the shoulder 20 and the inner surface 24.

In the case of the second sleeve 15, a drilling arrangement 12 is selected in which the shoulder 20 has a diameter which is equal to the diameter I¹ of the bore 28 of the first or second embodiment to be used. The second sleeve 15 is then mounted on the shaft 18 of the drilling arrangement 12, so that the shoulder 20 is received in the bore 28. The second sleeve 15 is mounted on the shaft 18 in the same way as described above until the shoulder 20 is received in the bore 28, thereby holding the second sleeve 15 on the shoulder 20 by friction between the shoulder 20 and the inner surface of the bore 28.

The drilling tool apparatus 10 further includes a sleeve protector 30 which is substantially cylindrical in shape having an outer diameter which is substantially equal to, or greater than, the outer diameter of the first sleeve 14. The sleeve protector 30 defines a central circular through aperture 32 which has a diameter which is substantially equal to the diameter of the shaft 18.

The sleeve protector 30 is mounted on the shaft 18 at the proximal end 18B, so that the shaft 18 extends through the central aperture 32. The sleeve protector 30 is then slid along the shaft 18 until it engages the proximal open end 14B of the first sleeve 14.

The proximal end 18B of the shaft 18 protrudes out of the proximal open end 14B of the first sleeve 14, and is mounted in the chuck of a drill (not shown). The chuck then tightened onto the proximal end 18B of the shaft 18 in the manner that would be known by the person skilled in the art.

The drill is then operated in the manner known in the art to drill a hole through a wall from a first side of the wall to a second opposite side. As the hole is formed, the first sleeve 14 is pushed into the hole so formed. When the hole has been drilled entirely through the wall, the drill is stopped, and the operator then disconnects the drilling arrangement 12 from the drill and then moves round to the second side of the wall to extract the drilling arrangement 12 from the hole and from the sleeve 14 by pulling the drilling arrangement 12 through the wall.

When the drilling arrangement 12 has been so removed, the sleeve 14 is retained within the wall by the fins 27 extending radially outwardly from the surface 22 to engage the internal surface of the hole.

In the embodiments described herein, the fins 27 provide the advantage that they hold the first and second sleeves 14, 15 in the wall. The fins 27 also provide the advantage during installation that they minimise the friction between the first or second sleeve 14, 15 and the internal surface of the hole being drilled. The area of contact between the fins 27 and the internal surface of the hole is much less than would be the case if the outer surface 22 of the sleeve engaged the internal surface of the hole. This facilitates the drilling stage by providing minimal frictional resistance between the sleeve and the internal surface of the hole being drilled.

After the removal of the drilling arrangement 10, if necessary, the first or second sleeve 14, 15 can be trimmed to a suitable length so that opposite ends thereof do not extend out of the wall. Cables can then be pushed through the sleeve which provides a path to allow them to be passed from one side of the wall to the other and when so arranged, the sleeve protects the cables from damage.

In the event that it is necessary to pass water or gas pipes through a wall, the second sleeve 15 shown in FIGS. 3 and 8 is desirably used. The insulation 26 helps to prevent the contents of the pipe from freezing. When the second sleeve has been mounted within the wall, the gas or water piping can then be fed therethrough. The second sleeve 15 provides a path to allow the piping to be passed through the wall and when installed, protects the piping.

There is thus described a drilling tool apparatus 10 and a method which allows a sleeve to be mounted within a hole in a wall to allow cables or piping to be passed therethrough. The first and second sleeves 14, 15 are provided with radially outwardly extending fins 27 which extend the length of the first or second sleeves 14, 15. The fins 27 provide the advantage that they reduce the friction between the first or second sleeve 14, 15 and the wall to facilitate the drilling of the hole in the wall and to allow the first or second sleeve 14, 15 to be passed easily into the hole. This can be important when the cutting head 16B has become worn so that the width W is slightly less than the diameter of the circle C circumscribed by the tips 27. The fins 27 also provide the advantage that, by virtue of the fact that they engage the internal surface of the hole drilled therethrough, the first or second sleeve 14, 15 is thereby securely mounted in the hole.

FIG. 9 shows a second embodiment of the drilling arrangement, generally designated 112. The drilling arrangement 112 comprises many of the features of the drilling arrangement 12 described above, and these features have been designated with the same reference numerals used to designate corresponding features in FIGS. 1, 4, 5 and 6. The drilling arrangement 112 can be used with the first or second sleeves 14, 15 described above, or can be used with a third sleeve, generally designated 114, shown in FIGS. 11 and 12 and described below.

The drilling arrangement 112 differs from the drilling arrangement 12 in that the drilling arrangement 112 does not possess a shoulder 20. Instead, the sleeve 14, 15 or 114 is held on the shaft 18 of the drilling arrangement 112 by a sleeve protector 130, in the form of an end cap. FIGS. 13, 14 and 15 show the sleeve protector 130, and its use is described below.

The drilling arrangement 112 also includes an end fitting arrangement 118 at the proximal end 18B of the shaft 18. The end fitting arrangement 118 is of a type known in the art as an SDS fitting, to allow it to be fitted to an SDS drill (not shown). It will, however, be appreciated that any other suitable end fitting arrangement could be provided at the proximal end 18B of the shaft 18 to allow the drilling arrangement 112 to be fitted to other suitable drills.

A third embodiment of the drilling arrangement, generally designated 212, is shown in FIG. 10. The drilling arrangement 212 comprises many of the features of the drilling arrangement 12, and these features have been designated with the same reference numerals used to designate corresponding features in FIGS. 1, 4, 5 and 6.

The drilling arrangement 212 differs from the drilling arrangement 12 in that it includes a shoulder 120 between the shaft 18 and the cutting means 16, the shoulder 120 being shorter than the shoulder 20 shown in FIGS. 1, 4 and 5.

The drilling arrangement 212 further includes the SDS end fitting arrangement 118 at the proximal end 18B of the shaft 18.

It will be appreciated that, instead of the SDS end fitting arrangement 118 on each of the drilling arrangements 112, 212, any other suitable end fitting can be used.

FIGS. 11 and 12 show the third sleeve 114, which comprises the elongate hollow substantially cylindrical member 21 having the outer surface 22 and an inner surface 24. The third sleeve 114 has open opposite ends 114A, 114B. The outer surface 22 defines a plurality of elongate axially extending grooves 127.

The grooves 127 are spaced from each other circumferentially around the substantially cylindrical member 21, and extend the whole length of the third sleeve 114. The grooves 127 provide the advantage in the embodiment described that they allow the third sleeve 114 to compress as the sleeve 114 passes through the hole drilled in the wall, thereby increasing the friction between the third sleeve 114 and the wall. A further advantage is that the sleeve 114 can be installed in holes of different diameters, which can be created as the drilling tip 16B wears.

The sleeve protector 130 comprises an annular body 132 on which a radially outwardly extending flange member 134 is provided. A through aperture 136 extends through the body 132 and the flange member 134, to allow the sleeve protector to be mounted on the shaft 18 to engage the sleeve 14, 14 or 114 when mounted thereon. The body 132 has an outer diameter of a size to allow it to be received within the sleeve 14, 15 or 114 and be a tight fit therein. The body 132 has an annular chamfered free end 138 to facilitate mounting the sleeve protector 130 on the shaft 18.

The use of the drilling arrangements 112 and 212 is now discussed. In the case of the drilling arrangement 112, shown in FIG. 9, the sleeve 114 is first disposed on the drilling arrangement 112, so that the shaft 18 extends through the sleeve 114, and the end 114A of the sleeve 114 engages the cutting means 16. The sleeve protector 130 is then mounted on the shaft 18 so that the main body 132 of the sleeve protector 130 is received in the end 114B thereof, and the flange member 134 engages the end 114B.

The drilling arrangement 112 or 212 is then secured to the drill in a manner known in the art, and a suitable hole is then drilled through the wall in the same way as described above. The drilling results in the sleeve 114 being inserted into the hole.

After the drilling is complete, the drilling arrangement 112 or 212 is removed from the drill, and the sleeve protector 130 is removed from the shaft 18 of the drilling arrangement 112 or 212. The drilling arrangement 112 or 212 is then pulled through the hole in the wall to leave the sleeve 114 disposed within the hole. The desired cables can then be inserted through the sleeve 114, thereby extending through the wall.

Various modifications can be made without departing from the scope of the invention. For example, the inner and out diameters of the first, second and third sleeves 14, 15, 114 may be varied, depending upon the size of drilling arrangements 12, 112, 212

1-72. (canceled)

73. A drilling tool apparatus comprising an elongate drilling arrangement for drilling a hole in a wall and an elongate sleeve mountable on the drilling arrangement, the drilling arrangement comprising an elongate shaft having proximal and distal ends, a cutting means at the distal end of the shaft for forming the hole, wherein the elongate shaft is receivable through the sleeve, and the sleeve comprises a substantially cylindrical member having an outer surface defining a plurality of grooves, each groove having a respective longitudinal axis extending along the length of the sleeve, the longitudinal axes of the grooves being circumferentially spaced from each other around said outer surface.

74. A drilling tool apparatus according to claim 73, wherein each groove extends substantially the whole length of the substantially cylindrical member, and wherein the substantially cylindrical member has an internal space which extends the length of the substantially cylindrical member.

75. A drilling tool apparatus according to claim 74, wherein the substantially cylindrical member has an inner surface and opposite open ends, the inner surface defining the aforesaid internal space whereby, when the shaft is received through the sleeve, the proximal end of the shaft is disposed axially beyond one end of the sleeve, and wherein the sleeve includes insulation in the internal space, the insulation being provided on the inner surface, and wherein the insulation defines a substantially central elongate bore through which the shaft can extend.

76. A drilling tool apparatus according to claim 73, including a sleeve protector mountable on the shaft between one end of the sleeve and the proximal end of the shaft, the sleeve protector comprising a circular member defining a substantially central aperture, the shaft being configured to extend through the central aperture.

77. A drilling tool apparatus according to claim 76, wherein the sleeve protector comprises a cylindrical member defining an aperture therethrough.

78. A drilling tool apparatus according to claim 76, wherein the sleeve protector comprises a cylindrical body and a radially outwardly extending flange member on the body, a through aperture being defined through the body and the flange member.

79. A drilling tool apparatus according to claim 73, wherein the drilling arrangement includes a locating portion for locating the sleeve on the shaft, the locating portion being provided on the shaft at the distal end thereof adjacent the cutting means.

80. A drilling tool apparatus according to claim 79, wherein the locating portion comprises a shoulder extending from the drilling arrangement to the shaft, and the locating portion. is configured to be received within the sleeve.

81. A method of forming a hole in a wall, the method comprising providing a drilling tool apparatus as claimed in claim 73, mounting the sleeve on the drilling arrangement such that the elongate shaft is received through the sleeve, connecting the drilling arrangement to the drill, and drilling said hole in the wall, wherein after the hole is formed, the drilling arrangement is removed from the sleeve, and the sleeve is retained in the hole.

82. A method according to claim 81, wherein the wall has first and second opposite sides, and the method comprises drilling the hole through the wall from the first side, disconnecting the drilling arrangement from the drill, and extracting the drilling arrangement from the sleeve and the wall from the second side of the wall, the sleeve thereby remaining in the hole.

83. A method according to claim 81, wherein each groove extends substantially the whole length of the substantially cylindrical member, and wherein the substantially cylindrical member has an internal space which extends the length of the substantially cylindrical member.

84. A method according to claim 83, wherein the substantially cylindrical member has an inner surface and opposite open ends, the inner surface defining the aforesaid internal space wherein the method comprises receiving the shaft through the sleeve, so that the proximal end of the shaft is disposed axially beyond one end of the sleeve, and wherein the sleeve includes insulation in the internal space, the insulation being provided on the inner surface, and wherein the insulation defines a substantially central elongate bore through which the shaft can extend.

85. A method according to claim 81, including a sleeve protector comprising a circular member defining a substantially central aperture, and the method comprises mounting the sleeve protector on the shaft between one end of the sleeve and the proximal end of the shaft, so that the shaft extends through the central aperture.

86. A method according to claim 85, wherein the sleeve protector comprises a cylindrical member defining an aperture therethrough.

87. A method according to claim 85, wherein the sleeve protector comprises a cylindrical body and a radially outwardly extending flange member on the body, a through aperture being defined through the body and the flange member.

88. A method according to claim 81, wherein the drilling arrangement includes a locating portion for locating the sleeve on. the shaft, the locating portion being provided on the shaft at the distal end thereof adjacent the drilling arrangement, and the method comprises engaging the shaft on the locating portion to locate the sleeve on the shaft. 89, (New) A method according to claim 88, wherein the locating portion comprises a shoulder extending from the drilling arrangement to the shaft, and the method comprises arranging the locating portion within the sleeve.

90. A sleeve for use with a drilling arrangement in a drilling tool apparatus as claimed in claim 73, the sleeve being elongate and comprising a substantially cylindrical member having an outer surface defining a plurality of grooves, each groove having a respective longitudinal axis extending along the length of the sleeve, the longitudinal axes of the grooves being circumferentially spaced from each other around said outer surface.

91. A sleeve according to claim 90, wherein each groove extends substantially the whole length of the substantially cylindrical member, and wherein the substantially cylindrical member has an internal space which extends the length of the substantially cylindrical member.

92. A sleeve according to claim 91, wherein the substantially cylindrical member has an inner surface and opposite open ends, the inner surface defining the aforesaid internal space whereby, when the shaft is received through the sleeve, the proximal end of the shaft is disposed axially beyond one end of the sleeve, and the sleeve including insulation in the internal space, the insulation being provided on the inner surface, and wherein the insulation defines a substantially central elongate bore through which the shaft can extend.
